(19) United States
(12) Patent Application Publication
(10) Pub. No.: US 2015/0312259 A1
(43) Pub. Date: Oct. 29, 2015

(54) Searching Private Content and Public Content

(71) Applicants: Shamim Alpha, Redwood Shores, CA (US); Daniel Belov, San Francisco, CA (US); Benjamin T. Smith, Mountain View, CA (US); Matthew E. Kulick, San Francisco, CA (US)

(72) Inventors: Shamim Alpha, Redwood Shores, CA (US); Daniel Belov, San Francisco, CA (US); Benjamin T. Smith, Mountain View, CA (US); Matthew E. Kulick, San Francisco, CA (US)

(21) Appl. No.: 13/604,947

(22) Filed: Sep. 6, 2012

Related U.S. Application Data
(60) Provisional application No. 61/531,382, filed on Sep. 6, 2011.

(51) Int. Cl. H04L 29/06

(52) U.S. Cl. CPC H04L 63/101; G06F 17/30864

(57) ABSTRACT

A method performed by one or more processing devices includes receiving, from a client device controlled by a user, a search query including one or more search terms and user information of the user; accessing, by a server device based on receipt of the search query, a private content index for indexing private content of users; wherein the private content index includes access control lists; identifying, based on a comparison of the access control lists to the user information received, private content that is accessible to the user; identifying private content that is responsive to the one or more search terms and that is accessible to the user; identifying, based on a search of public content by the server device, public content that is responsive to the one or more search terms; and sending, to the client device, search results for the identified private and public content.

### CLAIM OF PRIORITY

This application claims priority under 35 U.S.C. §119(e) to provisional U.S. Patent Application No. 61/531,382, filed on Sep. 6, 2012, the entire contents of which are hereby incorporated by reference.

### BACKGROUND

This disclosure relates generally to searching private content and public content.

A user can submit a search query to a search engine to search the World Wide Web for public content that is relevant to the search query. Generally, public content can include information without access restrictions, including, e.g., restrictions on who can view and/or access the information. Generally, a restriction can include a limiting condition.

Additionally, computer programs may allow users to search for private content. In some situations, the private content can be related to the computer program and stored by the computer program. Generally, private content includes information with access restrictions (e.g., through permissions in an access control list, stored on local storage that is not shared).

In an example, an electronic mail (e-mail) computer program stores e-mail messages sent by and received for a user. In this example, the e-mail messages include private content. Access to view the e-mail messages is restricted to users that have been authenticated by the e-mail computer program (e.g., using usemame and password login information). Through the e-mail computer program, the user can search the private content (e.g., e-mail messages) that is stored by the e-mail computer program.

### SUMMARY

In one aspect of the present disclosure, a method performed by one or more processing devices includes receiving, from a client device controlled by a user, a search query including one or more search terms and user information of the user; accessing, by a server device based on receipt of the search query, a private content index for indexing private content of users; wherein the private content index includes access control lists, and wherein an access control list identifies users authorized to access an item of private content; identifying, based on a comparison of the access control lists to the user information received, private content that is accessible to the user; identifying, based on a search of portions of the private content index associated with the private content that is accessible to the user, private content that is responsive to the one or more search terms and that is accessible to the user; identifying, based on a search of public content by the server device, public content that is responsive to the one or more search terms; and sending, to the client device, search results for the identified private and public content.

Implementations of the disclosure can include one or more of the following features. In some implementations, the method also includes generating information for a graphical user interface that when rendered on a display of the computing device displays the search results; wherein sending includes: sending the information for the graphical user interface to the client device. In other implementations, the method includes comparing the user information to information in the access control lists.

In still other implementations, the method includes ranking the search results. In some implementations, the portions of the private content index include index items, and an index item includes an access control list and information identifying an item of private content.

In some implementations, the method includes receiving the private content of the users; generating the access control lists for the private content received; generating, at least partly based on the private content received and the access control lists, index items, and generating, based on the index items, the private content index.

In some implementations, the private content that is accessible to the user includes at least one encrypted item of private content, and the method further includes: retrieving a key for the encrypted item of private content; and decrypting, with the key, the encrypted item of private content.

In still other implementations, the private content index is remote from the client device. In some implementations; the user that controls the client device is a first user, and the private content that is accessible to the first user is not accessible to one or more second users that differ from the first user.

In still another aspect of the disclosure, one or more machine-readable media are configured to store instructions that are executable by a server device to perform operations including receiving, from a client device controlled by a user, a search query including one or more search terms and user information of the user; accessing, based on receipt of the search query, a private content index for indexing private content of users; wherein the private content index includes access control lists, and wherein an access control list identifies users authorized to access an item of private content; identifying, based on a comparison of the access control lists to the user information received, private content that is accessible to the user; identifying, based on a search of portions of the private content index associated with the private content that is accessible to the user, private content that is responsive to the one or more search terms and that is accessible to the user; identifying, based on a search of public content, public content that is responsive to the one or more search terms; and sending, to the client device, search results for the identified private and public content. Implementations of this aspect of the present disclosure can include one or more of the foregoing features.

In still another aspect of the disclosure, an electronic system includes a server device; and one or more machine-readable media configured to store instructions that are executable by the server device to perform operations including: receiving, from a client device controlled by a user, a search query including one or more search terms and user information of the user; accessing, based on receipt of the search query, a private content index for indexing private content of users; wherein the private content index includes access control lists, and wherein an access control list identifies users authorized to access an item of private content; identifying, based on a comparison of the access control lists to the user information received, private content that is accessible to the user; identifying, based on a search of portions of the private content index associated with the private content that is accessible to the user, private content that is responsive to the one or more search terms and that is accessible to the user; identifying, based on a search of public content, public content that is responsive to the one or more search terms; and sending, to the client device, search results for the identified private and public content. Implementations of this aspect of the present disclosure can include one or more of the foregoing features.

Advantages of the present disclosure include one or more of the following. Users can search over both private and public contents through a single user interface, e.g., rather than using one user interface to search for public content and another, different user interface (or multiple different user interfaces) to search for private content. In an example, a user can use the system described herein to search the World Wide Web, the user's e-mail, and pictures that have been uploaded to a network by the user. In this example, a combined search over private and public contents increases an efficiency of the system in searching for content and reduces an amount of resources consumed by the system during searching.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is a conceptual diagram of an example system for searching private content and public content.

FIG. 2 is a block diagram of example components of the system for searching private content and public content.

FIG. 3 is a flowchart showing an example process for indexing items of private content.

FIG. 4 is a flowchart showing an example process for searching private content and public content.

FIG. 5 is a flowchart showing an example process for generating search results.

FIG. 6 shows a screen shot of an example graphical user interface for searching private content and public content.

FIG. 7 shows an example of a computer device and a mobile computer device that can be used to implement the techniques described herein.

Like reference symbols in the various drawings indicate like elements.

### DETAILED DESCRIPTION

Described herein is a system that provides a user interface for performing a search on public content and private content, including, e.g., web history information, social network content, and so forth. In an example, social network content includes communications in a social network website posts made by a user in the social network website, content, endorsements, and media posts shared with the user by others, contacts from a social graph, profiles, shared media, contacts currently online (and/or participating in chats, videoconferences, etc.), posts and related information, calendar information, e-mail messages, private pictures, private images, profile pages, private documents, and so forth.

In an example, the system determines private content and users that are authorized to access the private content. In some implementations, users can opt-in or opt-out of the system determining this information. In some implementations, the data can be anonymized to promote privacy of users. In this example, the system implements a hashing function to encrypt contents of e-mail messages and other content that the system identifies to anonymize. For example, in the context of emails, users that have access to the e-mail messages include the senders of e-mail message and the recipients of e-mail messages. In this example, the system stores the e-mail message and the senders/recipients of the e-mail message in an encrypted form to promote secure storage of the private content.

In an example, the system provides the user with a user interface for searching of private content and public content. When the system receives through the user interface a search query from the user, the system determines private content that is accessible to the user. The system determines items of content that are relevant to the search query by searching private content that is accessible to the user and/or public content. In an example, a user interface for searching of private content and public content includes a control that enables a user to search for public content only, private content only, and/or any combination thereof.

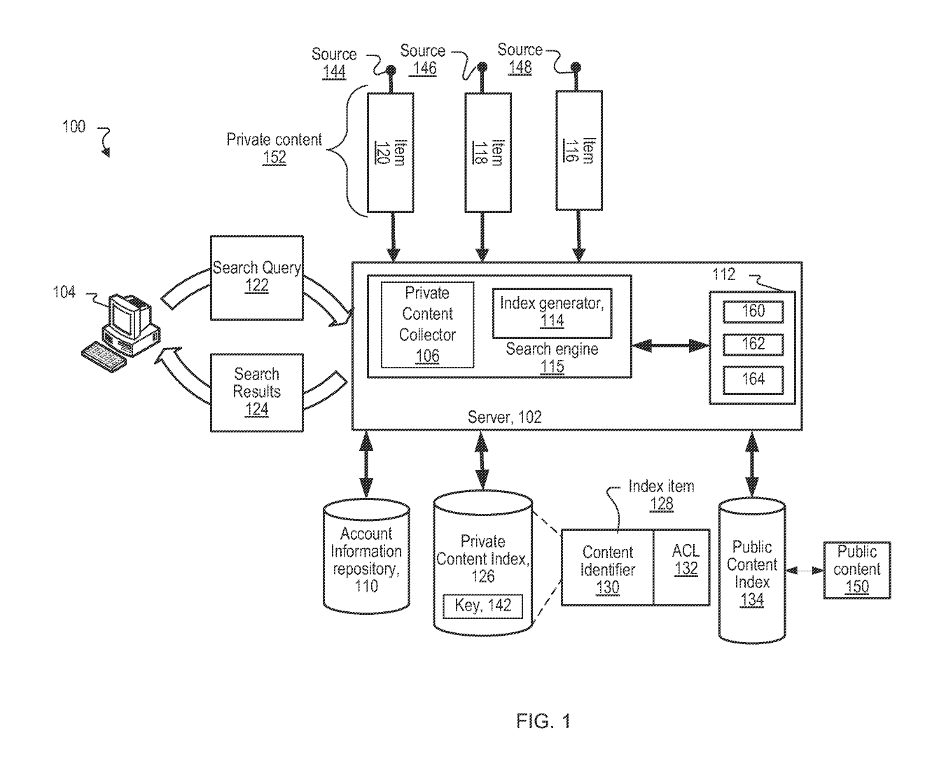

FIG. 1 is a conceptual diagram of system 100 for searching private content 152 and public content 150. System 100 includes server 102. Server 102 includes search engine 115 for searching of private and public content, as described in further detail below. Search engine 115 includes numerous components, including, e.g., private content collector 106 and index generator 114.

Private content collector 106 is configured to determine private content 152 from sources 144, 146, 148 of private content 152, including, e.g., social networking websites, picture hosting websites, online e-mail providers, and so forth, e.g., in accordance with the user's selection of the above-described controls.

In the example of FIG. 1, private content 152 includes a collection of items, including, e.g., items 116. 118, 120 of private content 152. Sources 144, 146, 148 send items 116, 118, 120 of private content 152 to private content collector 106. In an example, private content collector 106 is configured to crawl sources 144, 146, 148 to retrieve items 116, 118, 120 of private content 152. In still another example, sources 144, 146, 148 send items 116, 118, 120 of private content 152 to private content collector 106, for example, at pre-defined time intervals and/or when sources 144, 146, 148 include new items, e.g., items that were not previously sent to private content collector 106.

System 100 also includes account information repository 110. Account information repository 110 is configured to store information for accessing accounts associated with sources 144, 146, 148. For example, source 144 may be an e-mail provider. In this example, for private content collector 106 to crawl source 144, private content collector 106 uses information stored in account information repository 110 to access e-mail accounts of users of system 100. By accessing e-mail accounts of the users, private content collector 106 may retrieve items (e.g., item 120) from source 144. In an example, a user is provided with the option of specifying which private content may be collected by private content collector and/or of specifying only public content 150 is searched for the user.

In the example of FIG. 1, private content collector 10.6 receives items 116, 118, 120 of private content 152 from sources 144, 146, 148. Private content collector 106 is configured to format content in items 116, 118, 120 of private content 152 to comply with a standard for the storage and/or for the display of data. In an example, the standard specifies how different data elements and metadata coexist in a computer file, a particular way that information is encoded for storage in a computer file, how to convert a specific type of data to another type of data, and so forth. Private content collector 106 formats items 116, 118, 120 of private content 152 to promote efficient indexing of items 116, 118, 120 of private content 152, e.g., as described in further detail below.

In an example, private content collector 106 generates formatted items 160, 162 164 by formatting the content of items 116, 118, 120 of private content 152, respectively. Private content collector 106 groups together formatted items 160, 162, 164 into a collection, namely, formatted private content 112. In this example, formatted private content 112 is sent to other modules in server 102 as a data feed, e.g., rather than individually sending formatted items 160, 162, 164.

Index generator 114 is configured to index private content 152 and to index public content 150. In the example of FIG. 1, index generator 114 generates private content index 126 that indexes private content 152. In an example, private content index 126 uses hash functions to encrypt portions of items of private content to promote secure storage of the items of private content. Using formatted items 160, 162, 164, index generator 114 generates index items and stores the index items in private content index 126. Generally, an index item includes information that indexes an item of private content 152.

Index generator 114 generates index item 128 to index item 116 of private content 152. As described in further detail below, index generator 114 uses contents of formatted item 160 to index item 116 of private content 152. Index generator 114 also generates index items (not shown) for items 118, 120.

Index item 128 includes access control list (ACL) 132 with access information. Generally, access information includes information specifying identities of users that are authorized to access an item of content. In an example, index generator 114 determines users that are authorized to access item 116 of private content 152. In this example, item 116 includes user information (not shown), e.g., information specifying identities of users. The user information included in item 116 includes identities of users that are authorized to access item 116 of private content 152, as determined by source 148. In other examples, the user information includes information specifying an identity of a user that sent information, e.g., an identity of user submitting a search query.

Using the user information in item 116, private content collector 106 formats the user information for inclusion in formatted item 160. Index generator 114 accesses formatted item 160. Using the user information in formatted item 160, index generator 114 determines users authorized to access item 116 of private content 152. In this example, index generator 114 adds to ACL 132 names of users included in formatted item 160. in an example, item 116 of private content 152 is an e-mail message. In this example, formatted item 160 includes a formatted version of contents of the e-mail message. Using contents of formatted item 160, index generator 114 determines that the sender and the recipients of the e-mail message are authorized to access the e-mail message (e.g., item 116 of private content 152).

In still another example, formatted item 160 includes account information from account information repository 110, e.g., when private content collector 106 uses account information to retrieve item 116 of private content 152 from source 148. In this example, index generator 114 adds to ACL 132 the account information.

Index item 128 also includes content identifier 130, including, e.g., portions of item 116 of private content 152 that index generator 114 has determined are relevant for identifying and/or for searching contents of item 116 of private content 152, information describing contents of item 116 of private content 152, keywords for item 116 of private content 152, and/or a unique identifier for item 116 of private content 152. In this example, index generator 114 generates content identifier 130 by parsing contents of formatted item 160.

Using parsed contents of formatted item 160, index generator 114 determines keywords, attributes, etc. of item 116 of private content 152. Content identifier 130 may also include reference information. Generally, reference information includes information specifying a location of an item, including, e.g., a uniform resource location (URL) or other network location. In the example of FIG. 1, reference information includes information specifying a location of sources 144, 146, 148.

In another example, reference information may be linked to index item 128 and stored in a separate repository (not shown). Content identifier 130 promotes a searching of private content index 126 to determine whether an item of private content 152 is relevant to search query 122, e.g., rather than searching the entire contents of item 116. In the example of FIG. 1, search query 122 includes numerous types of search queries, including, e.g., search queries for images, search queries for documents, search queries for web sites, and search queries for other resources.

In an example, items 116, 118, 120 of private content 152 include sensitive and/or confidential information (collectively referred to herein as confidential information, without limitation, for purposes of convenience). In an example, item 116 of private content 152 includes confidential information. The confidential information is also included in formatted item 160. When generating content identifier 130 of index item 128, index generator 114 includes at least a portion of the confidential information in content identifier 130.

In this example, to promote secure storage of the confidential information in index item 128, index generator 114 encrypts content identifier 130 using an encryption key, namely, key 142. Prior to including index item 128 in a search, search engine 115 determines that a user requesting the search has access to confidential information in content identifier 130, as described in further detail below.

In still another example, identifying portion 130 of index item 128 may be associated with a wrapped key (not shown). Generally, a wrapped key includes an encrypted key. To unwrap (e.g., decrypt) the wrapped key, server 102 sends the wrapped key to another security system (not shown). The security system sends to server 102 the unwrapped key, which is used by search engine 115 to decrypt content identifier 130.

In an example, index generator 114 also generates public content index 134 for public content 150, including, e.g., publically accessible web pages, publically accessible websites, publically accessible documents, and other publically accessible information. Index generator 114 generates public content index 134, for example, by crawling the World Wide Web and indexing web pages, as is commonly known in the art.

In the example of FIG. 1, system 100 also includes client device 104. Using client device 104, a user (not shown) submits search query 122 to server 102. In this example, search query 122 includes one or more search terms.

Search engine 115 receives search query 122. In the example of FIG. 1, search engine 115 searches both private content 152 and public content 150. Using contents of search query 122, search engine 115 determines which items 116, 118, 120 of private content 152 the user has permission to access.

In this example, search query 122 includes user information specifying an identity for the user submitting search query 122. In an example, the user information is stored in a cookie that is submitted with and/or included in search query 122. A cookie includes a type of message that is given to a Web browser by a Web server. A cookie is used by the Web server to identify users. In the example of FIG. 1, server 102 may include a Web server.

In an example, a user of client device 104 accesses a Web site that includes a Web page for submission of search query 122. In this example, the Web site uses cookies. Prior to submission of search query 122, the Web site includes another Web page that prompts the user to fill out a form with user information, including, e.g., name information, e-mail address information, and so forth. Server 102 receives the user information and packages the user information into a cookie. Server 102 sends the cookie to a Web browser running on client device 104. Client device 104 stores the cookie for later use, e.g., when the user submits search query 122.

When the user access the Web site to submit search query 122, the browser running on client device 104 sends the cookie to the server 102. Using the user information in the cookie, server 102 determines an identity of the user.

Using the user information, search engine 115 determines private content that is accessible to the user. In an example, search engine 115 scans ACLs of the index items in private content index 126 to determine which of items 116, 118, 120 of private content 152 are accessible to the user submitting search query 122. Rather than searching the index items in private content index 126, search engine 115 may be configured to only search index items indexing private content that is accessible to the user.

In an example of FIG. 1, search engine 115 determines whether the user submitting search query 122 has access to item 116 of private content 152. In this example, search engine 115 compares the user information in search query 122 to information in ACL 132. If the user information in search query 122 matches information in ACL 132, search engine 115 determines that the user has access to item 116 of private content 152. Search engine 115 retrieves key 142 from private content index 126 and uses key 142 to decrypt confidential information in content identifier 130. In this example, search engine 115 searches the decrypted confidential information included in content identifier 130.

In another example, search engine 115 determines that the user does not have access to item 116 of private content 152. In this example, search engine 115 does not include index item 128 in its search of private content repository 126.

Following a determination that the user has access to item 116 of private content 152, search engine 115 determines a relevancy of item 116 of private content 152 to search query 122. In this example, search engine 115 determines a relevance score for item 116 of private content 152 using content identifier 130 and search terms included in search query 122. Generally, a relevance score includes a measure of importance of an item of information to a particular item of information, e.g., relative to relevance of other items of information to the particular item of information.

In the example of FIG. 1, search engine 115 identifies items 116, 118, 120 of private content 152 as relevant to search query 122. Search engine 115 generates search results for items 116, 118, 120 of private content 152. Generally, a search result includes information describing the contents of an item of information and a reference to a location of the item of information. Generally, a reference includes a link and/or a pointer from one item of information to another item of information.

Search engine 115 also searches public content index 134 for items of public content 150 that may be relevant to search query 122. For items of public content identified as relevant to search query 122, search engine 115 also generates search results for the items of public content 150.

Search engine 115 generates search results 124 by combining search results for items 116, 118, 120 of private content 152 with the search results for items of public content 150 that are relevant to search query 122. In an example, search engine 115 ranks search results 124 in accordance with relevance of search results 124 to search query 122.

Search engine 115 sends search results 124 to client device 104.

In example, a user of client device 104 selects a search result to view item 116 of private content 152.. In this example, upon selection of the search result, client device 104 sends a request (not shown) to view item 116 of private content to source 148, e.g., using the reference included in the search result. The request includes user information, e.g., specifying a user name and/or other information that identifies the user submitting the request.

To promote secure access to confidential information in item 116 of private content 152, search engine 115 may be configured to intercept the request to again verify that the user has access to item 116 of private content 152. In an example, search engine 115 sends private content index 126 the request to view item 116 of private content 152 and the user information. Using the user information, search engine 115 determines whether the user has access to view item 116 of private content 152, for example based on information in ACL 132, as described above. If search engine 115 determines that the user has access to item 116 of private content 152, search engine 115 passes the request for item 116 of private content 152 to source 148. In response, source 148 sends item 116 to client device 104 for display on client device 104.

In a variation of FIG. 1, index generator 114 may generate a single index for indexing private content 152 and public content 150, e.g., rather than generating separate indexes, namely, private content index 126 and public content index 134.

In still another variation of FIG. 1, index generator 114 may generate individual private and public content indexes for users of system 100, e.g., rather than generating private and public content indexes 126, 134, which may index private content 152 and public content 150. In an example, index generator 114 generates an index (not shown) indexing items of private content that are accessible to a particular user. In this example, index generator 114 also generates another, different index (not shown) indexing items of public content that are also accessible to the particular user.

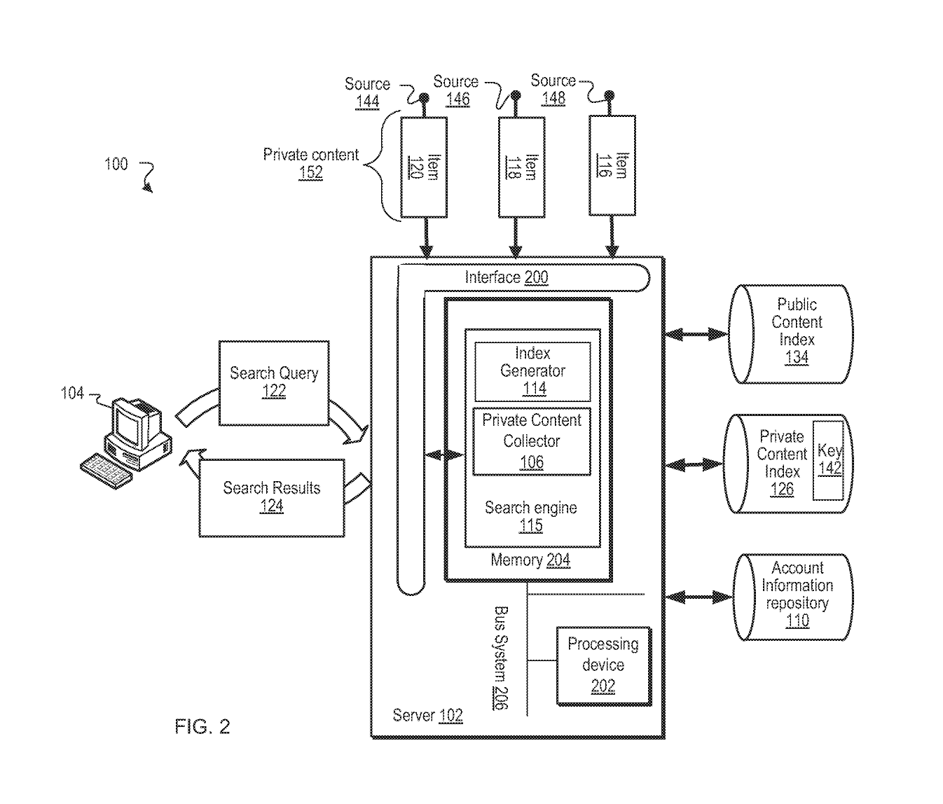

FIG. 2 is a block diagram of example components of system 100 for searching private content 152 and public content 150. In the example of FIG. 2, formatted private content 112, formatted items 160, 162, 164, index item 128, content identifier 130, ACL 132, and public content 150 are not shown.

Client device 104 can be a computing device capable of taking input from a user and communicating over a network (not shown) with server 102 and/or with other client devices. For example, client device 104 can be a computer, e.g.,, a desktop computer, a laptop, a mobile phone (e.g., a smartphone), a personal digital assistant (“PDA”), a server, an embedded computing system, and the like. Although a single client device 104 is shown in FIGS. 1 and 2, system 100 can include a plurality of client devices, which can be geographically dispersed.

Server 102 can be a of a variety of computing devices capable of receiving information and running one or more services, which can be accessed by client device 104. In an example, server 102 can include a server, a distributed computing system, a desktop computer, a laptop, a cell phone, a rack-mounted server, and the like. Server 102 can be a single server or a group of servers that are at a same location or at different locations. Client device 104 and server 102 can run programs having a client-server relationship to each other. Although distinct modules are shown in the figures, in some examples, client and server programs can run on the same device.

Server 102 can receive information from client device 104 and from sources 144, 146, 148 through input/output (“I/O”) interface 200. I/O interface 200 can be a type of interface capable of receiving information over a network, including, e.g., an Ethernet interface, a wireless networking interface, a fiber-optic networking interface, a modern, and the like. Server 102 also includes a processing device 202 and memory 204. A bus system 206, including, for example, a data bus and a motherboard, can be used to establish and to control data communication between the components of server 102.

Processing device 202 can include one or more microprocessors. Generally, processing device 202 can include an appropriate processor and/or logic that is capable of receiving and storing data, and of communicating over a network (not shown). Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs include index generator 114, search engine 115, and private content collector 106. In an example, index generator 114 and/or private content collector 106 may be included as components of search engine 115.

In an example, private content collector 106 is configured to retrieve items 116, 118, 120 of private content 152 from sources 144, 146, 148 that have been specified by a user of system 100. In this example, a user may input into client device 104 source information (not shown), namely, information identifying sources 144, 146, 148 as providers of private content 152. Client device 104 sends the source information to server 102. Private content collector 106 uses the source information in identifying sources 144, 146, 148 as providers of private content 152 and in collecting items 116, 118, 120 of private content 152 from sources 144, 146, 148.

In this example, the user also inputs into client device 104 account information to access the user's accounts with sources 144, 146, 148. Client device 104 sends the account information to server 102. Server 102 stores the account information in account information repository 110. Server 102 also tags the account information with information specifying the source associated with the account information.

In an example, search engine 115 is configured to add restrictions to search query 122, e.g., to promote searching of index items that include information that is accessible to a user submitting the search. Search engine 115 adds restrictions specifying that only items 116, 118, 120 of private content 152 that are accessible to the user are searched. In this example, using the restrictions added to search query 122, search engine 115 determines which of items 116, 118, 120 of private content 152 are accessible to the user. Search engine 115 may determine which of items 116, 118, 120 of private content 152 are accessible to the user by comparing the user information in search request 122 to the ACLs included in the index items, e.g., ACL 132 in index item 128. As previously described, search engine 115 searches the index items corresponding to items of private content 152 that are accessible to the user.

In an example, a user may change permission settings on items 116, 118, 120 of private content 152, e.g., by changing identities of other users authorized to access items 116, 118, 120 of private content 152, by changing the type of permission granted to other users for items 116, 118, 120 of private content 152, and so forth.

In an example, item 116 of private content 152 includes a private photograph and source 148 is a photograph hosting service. In this example, item 116 of private content 152 is uploaded to source 148 by a user. During uploading, the user specifies names of other users that may view item 116 of private content 152. As previously described, item 116 of private content 152 includes (and/or is associated with) user information specifying names of users authorized to access item 116 of private content 152. As part of the indexing process, index generator 114 includes the names of these users in ACL 132.

In this example, the user that uploaded item 116 of private content 152 to source 148 changes the identities of the other users that are authorized to view item 116 of private content 152, e.g., by granting additional users access to view item 116 of private content 152, by removing access for users to view item 116 of private content 152, by changing types of permission associated with users authorized to view item 116 of private content 152, and so forth. In this example, the user that uploaded item 116 of private content 152 may change the type of permission of other users by changing whether another user has access to view item 116 of private content 152, has access to edit item 116 of private content 152, has access to share item 116 of private content 152 with other users, and so forth.

In an example, when source 148 detects a change in the permissions for item 116 of private content 152, source 148 sends to private content collector 106 a notification (not shown) of the change. In response, private content collector 106 sends the notification to index generator 114, which uses the notification to update ACL 132 in index item 128.

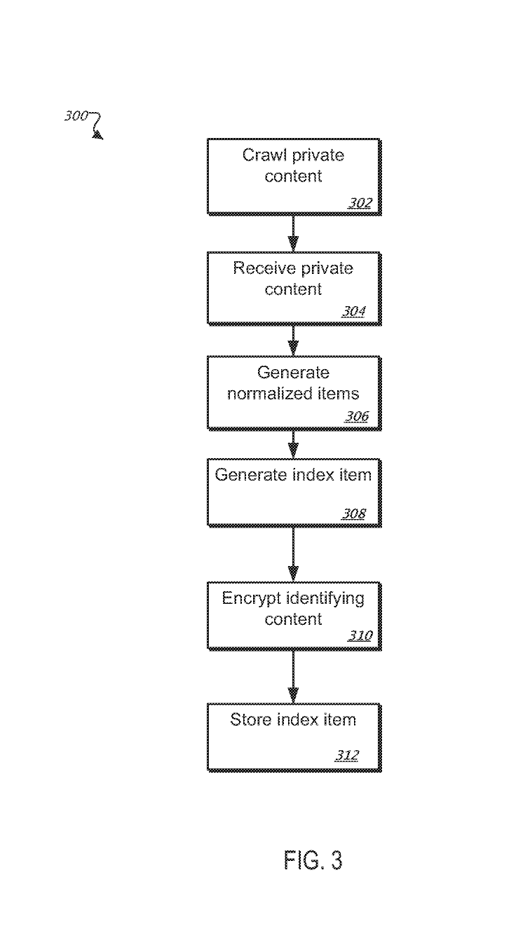

FIG. 3 is a flowchart showing process 300 for indexing items 116, 118, 120 of private content 152. In operation, private content collector 106 crawls (302) sources 144, 146, 148. In response, private content collector 106 receives (304) items 116, 118, 120 of private content 152. By formatting contents of items 116, 118, 120 of private content 152, private content collector 106 generates (306) formatted items 160, 162, 164. Index generator 114 parses (not shown) contents of formatted items 160, 162, 164 and generates (308) index items, e.g., index item 128 with content identifier 130 and ACL 132 (FIG. 1).

Using key 142 (FIG. 1), index generator 114 encrypts (310) confidential information in content identifier 130. Index generator 114 stores (312) index item 128, with encrypted confidential information stored in content identifier 130, in private content index 142.

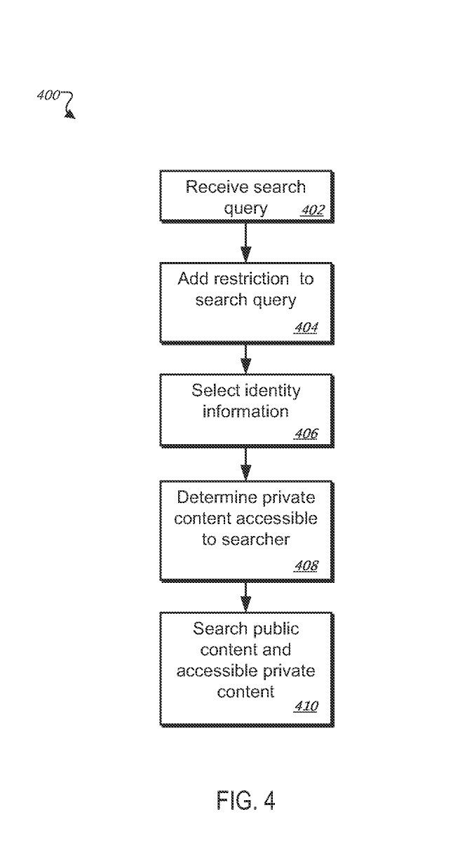

FIG. 4 is a flowchart showing process 400 for searching private content 152 and public content 150. In operation, search engine 115 receives (402) search query 122. In response, search engine 115 adds (404) to search query 122 restrictions specifying that search engine 115 only search for items of private content 152 that are accessible to the user submitting search query 122. Search engine 115 also selects (406) user information included in search query 122, as previously described. Based on the user information, search engine 115 determines (408) which of items 116, 118, 120 of private content 152 are accessible to the user. As previously described, search engine 116 may make this determination by comparing the user information to ACLs in index items stored in private content index 126, e.g., ACL 132 in index 128.

In the example of FIG. 4, search engine 115 searches (410) private content 152 accessible to the user and public content 150 for items that are relevant to search query 122. In an example, search engine 115 determines that item 116 of private content 152 is accessible to the user. Prior to searching content identifier 130 of index item 128, search engine 128 uses key 142 to decrypt the encrypted confidential information in content identifier 130.

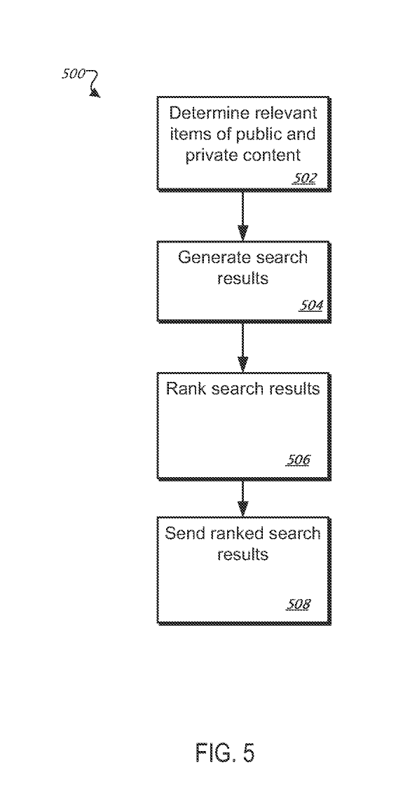

FIG. 5 is a flowchart showing process 500 for generating search results 124. In operation, search engine 115 determines (502) items of private content and items of public content that are relevant to search query 122. In this example, search engine 115 determines whether item 116 of private content 152 is relevant to search query 122 by searching content identifier 130 of index item 128 for terms and/or content that is relevant to search query 122. In an example, search engine 115 is configured to select items of private content 152 and items of public content 150 with increased relevancy to search query 122, e.g., relative to relevancy of other items of private content 152 and other items of public content 150 to search query 122. For example, search engine 115 may select items of private content 152 and public content 150 with a relevancy score that exceeds a relevancy threshold. In other example, search engine 115 may select a predefined number items of private content 152 and public content 150 with increased relevancy to search query 122, e.g., relative to relevancy of other items to search query 122.

In the example of FIG. 5, search engine 115 generates (504) search results 124 for the determined items of private content 150 and public content 150 that are relevant to search query 122. Search engine 115 ranks (506) search results 124, e.g., in accordance with a ranking formula. Search engine 115 sends (508) search results 124 to client device 104.

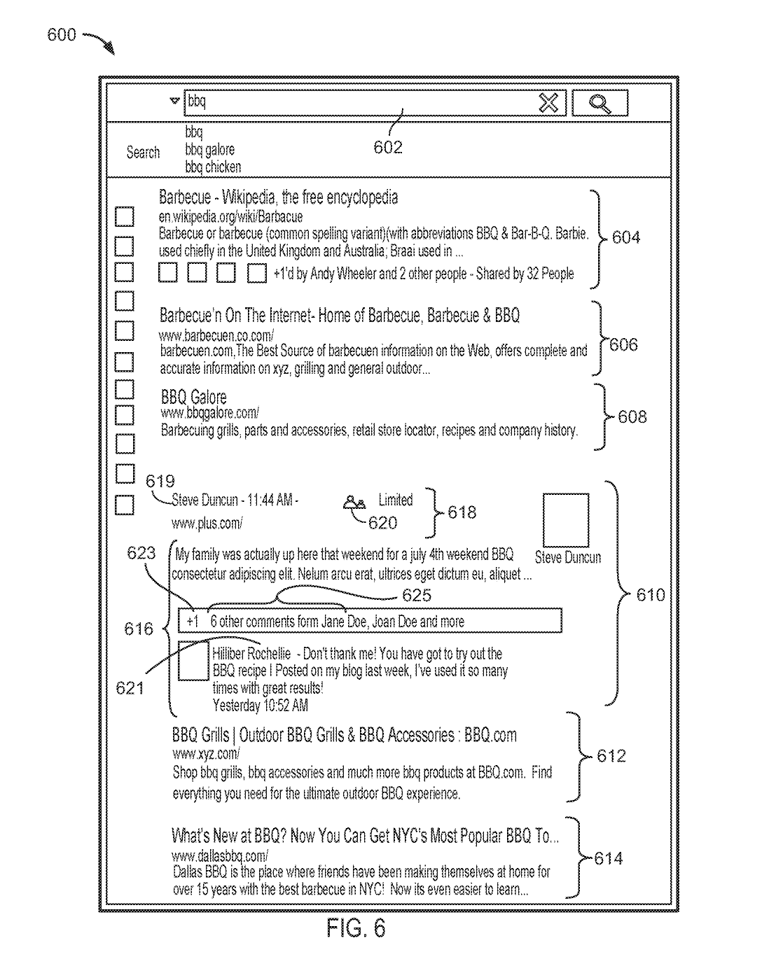

FIG. 6 shows graphical user interface 600 for searching private content 152 and public content 150. Graphical user interface 600 includes search portion 602 for input of a search query, e.g., search query 122 (FIG. 1). Graphical user interface 600 also displays contents of search results 124. An example search result can include a Web page title, a snippet of text or a portion of an image extracted from the Web page, and an identifier, including, e.g., a Unified Resource Location (URL) of the Web page.

In this example, search results 124 include search result items 604, 606, 608, 610, 612, 614. Search result items 604, 606, 608, 612, 614 include search results for items of public content 150.

In the example of FIG. 6, search result item 610 includes a search result for item 116 of private content 152. In this example, item 116 of private content 152 includes a forum page of a social networking website. Search result item 610 includes identifier 618. In the example of FIG. 6, identifier 618 includes link to a URL for item 116 of private content 152.

Search result item 610 also includes snippet 616 that includes comments, posts, and other information included in item 116 of private content 152 that is accessible to the user submitting search query 122. In an example, search engine 115 may generate snippet 616 from information included in content identifier 130 (FIG. 1). In an example, contents of snippet 616 may change based on the type of permission that has been granted to the user viewing the search result item.

In the example of FIG. 6, identifier 618 includes a reference to a location (e.g., a URL) for item 116 of private content 152 at source 148 (e.g., a posting on a social networking website). Selection of the URL sends a request to view item 116 of private content 152. As previously described, server 102 may be configured to intercept the request to view item 116 of private content 152 to confirm that the user still has access to view item 116 of private content 152. For example, permission for the user to view and/or to access item 116 of private content 152 may have changed from when search result item 610 was displayed in graphical user interface 600. If server 102 determines that the user still has access to view item 116 of private content 152, server 102 passes the request onto source 148.

Search result item 610 also includes identifiers 619, 621, 623, 625. In the example of FIG. 1, identifier 619 is a reference to a webpage for an author of item 116 of private content 152. Identifier 621 is a reference to a webpage of a user that has posted a comment to item 116 of private content 152.

In the example of FIG. 6, users of the social networking website may post comments and perform other actions on item 116 of private content 152. In this example, a user of the social networking website may endorse item 116 of private content 152 through selection of identifier 623. The user of the social networking website may also view comments to the posting represented by item 116 of private content 152 made by other users, e.g., through selection of identifier 625.

In an example, search result item 610 also includes icon 620, specifying an access level for the user viewing search result item 610. Generally, an access level includes information specifying an amount and/or a type of permission that has been granted to an entity. In the example of FIG. 6, icon 620 displays information specifying that the user viewing search result item 610 has limited access to item 116 of private content 152.

Using the techniques described herein, a system provides a user interface for searching of private content and public content. The system receives private content from numerous sources. The system indexes portions of the private content for searching by a search engine. The system also indexes portions of the public content for searching the by search engine. Additionally, the portions of the private content that include confidential information are encrypted to promote a storage of the confidential information.

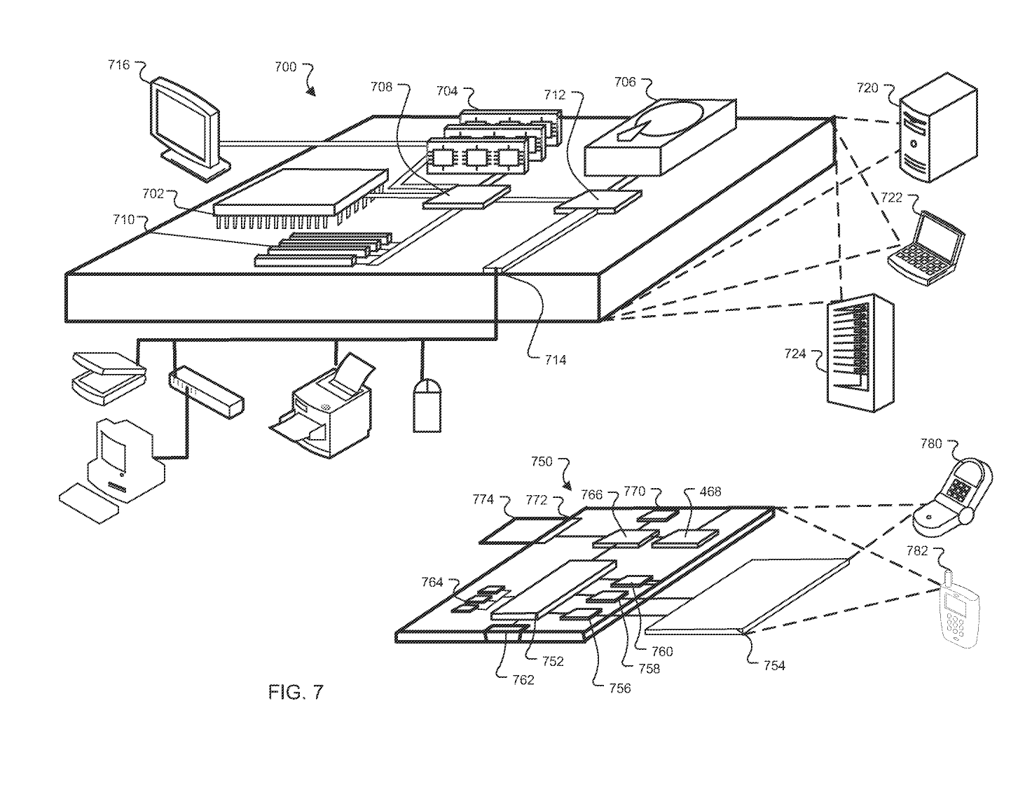

FIG. 7 shows an example of computer device 700 and mobile computer device 750, which can be used with the techniques described here. Computing device 700 is intended to represent various forms of digital computers, including, e.g., laptops, desktops, workstations, personal digital assistants, servers, blade servers, mainframes, and other appropriate computers. Computing device 750 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 700 includes processor 702, memory 704, storage device 706, high-speed user interface 708 connecting to memory 704 and high-speed expansion ports 710, and low speed user interface 712 connecting to low speed bus 714 and storage device 706. Each of components 702, 704, 706, 708, 710, and 712, are interconnected using various busses, and can be mounted on a common motherboard or in other manners as appropriate. Processor 702 can process instructions for execution within computing device 700, including instructions stored in memory 704 or on storage device 706 to display graphical information for a GUI on an external input/output device, including, e.g., display 716 coupled to high speed user interface 708. In other implementations, multiple processors and/or multiple buses can be used, as appropriate, along with multiple memories and types of memory. Also, multiple computing devices 700 can be connected, with each device providing portions of the necessary operations (e.g., as a server bank, a group of blade servers, or a multi-processor system).

Memory 704 stores information within computing device 700. In one implementation, memory 704 is a volatile memory unit or units. In another implementation, memory 704 is a non-volatile memory unit or units. Memory 704 also can be another form of computer-readable medium, including, e.g., a magnetic or optical disk.

Storage device 706 is capable of providing mass storage for computing device 700. In one implementation, storage device 706 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product also can contain instructions that, when executed, perform one or more methods, including, e.g., those described above. The information carrier is a computer- or machine-readable medium, including, e.g., memory 704, storage device 706, memory on processor 702, and the like.

High-speed controller 708 manages bandwidth-intensive operations for computing device 700, while low speed controller 712 manages lower bandwidth-intensive operations. Such allocation of functions is an example only. In one implementation, high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 700 can be implemented in a number of different forms, as shown in the figure. For example, it can be implemented as standard server 720, or multiple times in a group of such servers. It also can be implemented as part of rack server system 724. In addition or as an alternative, it can be implemented in a personal computer including, e.g., laptop computer 722. In some examples, components from computing device 700 can be combined with other components in a mobile device (not shown), including, e.g., device 750. Each of such devices can contain one or more of computing device 700, 750, and an entire system can be made up of multiple computing devices 700, 750 communicating with each other.

Computing device 750 includes processor 752, memory 764, an input/output device including, e.g., display 754, communication user interface 766, and transceiver 768, among other components. Device 750 also can be provided with a storage device, including, e.g., a microdrive or other device, to provide additional storage. Each of components 750, 752, 764, 754, 766, and 768, are interconnected using various buses, and several of the components can be mounted on a common motherboard or in other manners as appropriate.

Processor 752 can execute instructions within computing device 750, including instructions stored in memory 764. The processor can be implemented as a chipset of chips that include separate and multiple analog and digital processors. The processor can provide, for example, for coordination of the other components of device 750, including, e.g., control of user interfaces, applications run by device 750, and wireless communication by device 750.

Processor 752 can communicate with a user through control user interface 758 and display user interface 756 coupled to display 754. Display 754 can be, for example, a TFT LCD (Thin-Film-Transistor Liquid Crystal Display) or an OLED (Organic Light Emitting Diode) display, or other appropriate display technology. Display user interface 756 can comprise appropriate circuitry for driving display 754 to present graphical and other information to a user. Control user interface 758 can receive commands from a user and convert them for submission to processor 752. In addition, external user interface 762 can communicate with processor 742, so as to enable near area communication of device 750 with other devices. External user interface 762 can provide, for example, for wired communication in some implementations, or for wireless communication in other implementations, and multiple user interfaces also can be used.

Memory 764 stores information within computing device 750. Memory 764 can be implemented as one or more of a computer-readable medium or media, a volatile memory unit or units, or a non-volatile memory unit or units. Expansion memory 774 also can be provided and connected to device 750 through expansion user interface 772, which can include, for example, a SIMM (Single In Line Memory Module) card user interface. Such expansion memory 774 can provide extra storage space for device 750, or also can store applications or other information for device 750. Specifically, expansion memory 774 can include instructions to carry out or supplement the processes described above, and can include secure information also. Thus, for example, expansion memory 774 can provide a security module for device 750, and can be programmed with instructions that permit secure use of device 750. In addition, secure applications can be provided through the SIMM cards, along with additional information, including, e.g., placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, including, e.g., those described above. The information carrier is a computer- or machine-readable medium, including, e.g., memory 764, expansion memory 774, and/or memory on processor 752 that can be received, for example, over transceiver 768 or external user interface 762.

Device 750 can communicate wirelessly through communication user interface 766, which can include digital signal processing circuitry where necessary. Communication user interface 766 can provide for communications under various modes or protocols, including, e.g., GSM voice calls, SMS, EMS, or MMS messaging, COMA, TDMA, PDC, WCDMA, CDMA2000, or GPRS, among others. Such communication can occur, for example, through radio-frequency transceiver 768. In addition, short-range communication can occur, including, e.g., using a Bluetooth®, WiFi, or other such transceiver (not shown). In addition, GPS (Global Positioning System) receiver module 770 can provide additional navigation- and location-related wireless data to device 750, which can be used as appropriate by applications running on device 750.

Device 750 also can communicate audibly using audio codec 760, which can receive spoken information from a user and convert it to usable digital information. Audio codec 760 can likewise generate audible sound for a user, including, e.g., through a speaker, e.g., in a handset of device 750. Such sound can include sound from voice telephone calls, can include recorded sound (e.g., voice messages, music files, and the like) and also can include sound generated by applications operating on device 750.

Computing device 750 can be implemented in a number of different forms, as shown in the figure. For example, it can be implemented as cellular telephone 780. It also can be implemented as part of Smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

In some implementations, the engines described herein can be separated, combined or incorporated into a single or combined engine. The engines depicted in the figures are not intended to limit the systems described here to the software architectures shown in the figures.

Processes described herein and variations thereof (referred to as “the processes”) include functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method comprising:
identifying a plurality of private content items of one or more users;
for each private content item, i) identifying one or more portions of the private content item that are determined to be relevant for identifying the private content item in response to one or more search queries, and ii) parsing the private content item to generate a content identifier based on the identified portions of the private content;
generating, for each private content item, an index item, the index item including i) the content identifier, and ii) an access control list identifying users authorized to access the private content item;
generating a private content index based on the indexed items;
receiving, from a client device controlled by a particular user, i) search query including one or more search terms and ii) user information of the particular user;
identifying, based on a comparison of the access control list for each private content item to the user information, one or more of the plurality of private content items that are accessible to the particular user to provide accessible private content items;
modifying the search query to include one or more restrictions, the one or more restrictions specifying that only the accessible private content items of the plurality of private content items are accessible to the particular user;
identifying, based on a search of the content identifiers of the private content index one or more of the plurality of the accessible private content items i) based on the one or more restrictions and ii) that are responsive to the one or more search terms of the search query;
identifying, based on a search of public content, public content items that are responsive to the one or more search terms; and
sending, to the client device, search results including i) the identified accessible private content items and ii) the public content items.

2. The method of claim 1, further comprising:
generating information for a graphical user interface that when rendered on a display of the client device displays the search results;
wherein sending further comprises:
sending the information for the graphical user interface to the client device.

3. The method of claim 1, further comprising:
comparing the user information to information in the access control lists.

4. The method of claim 1, further comprising:
ranking the search results.

5. (canceled)

6. (canceled)

7. The method of claim 1, wherein the accessible private content items comprises at least one encrypted item of private content, and wherein the method further comprises:
retrieving a key for the encrypted item of private content; and
decrypting, with the key, the encrypted item of private content.

8. The method of claim 1, wherein the private content index is remote from the client device.

9. The method of claim 1, wherein the accessible private content items are not accessible to one or more other users that differ from the particular user.

10. One or more non-transitory machine-readable media configured to store instructions that are executable by a server device to perform operations comprising:
identifying a plurality of private content items of one or more users;
for each private content item, i) identifying one or more portions of the private content item that are determined to be relevant for identifying the private content item in response to one or more search queries, and ii) parsing the private content item to generate a content identifier based on the identified portions of the private content;
generating, for each private content item, an index item, the index item including i) the content identifier, and ii) an access control list identifying users authorized to access the private content item;
generating a private content index based on the indexed items;
receiving, from a client device controlled by a particular user, i) a search query including one or more search terms and ii) user information of the particular user;
identifying, based on a comparison of the access control list for each private content item to the user information, one or more of the plurality of private content items that are accessible to the particular user to provide accessible private content items;
modifying the search query to include one or more restrictions, the one or more restrictions specifying that only the accessible private content items of the plurality of private content items are accessible to the particular user;
identifying, based on a search of the content identifiers of the private content index one or more of the plurality of the accessible private content items i) based on the one or more restrictions and ii) that are responsive to the one or more search terms of the search query;
identifying, based on a search of public content, public content items that are responsive to the one or more search terms; and
sending, to the client device, search results including i) the identified accessible private content items and ii) the public content items.

11. (canceled)

12. (canceled)

13. The one or more non-transitory machine-readable media of claim 10, wherein the private content index is remote from the client device.

14. The one or more non-transitory machine-readable media of claim 10, wherein the accessible private content items is are not accessible to one or more other users that differ from the first user.

15. An electronic system comprising:
a server device; and
one or more machine-readable media configured to store instructions that are executable by the server device to perform operations comprising:
identifying a plurality of private content items of one or more users;
for each private content item, i) identifying one or more portions of the private content item that are determined to be relevant for identifying the private content item in response to one or more search queries, and ii) parsing the private content item to generate a content identifier based on the identified portions of the private content;
generating, for each private content item, an index item, the index item including i) the content identifier, and ii) an access control list identifying users authorized to access the private content item;
generating a private content index based on the indexed items;
receiving, from a client device controlled by a particular user, i) search query including one or more search terms and ii) user information of the user;
accessing, based on receipt of the search query, the private content index;
identifying, based on a comparison of the access control list for each private content item to the user information, one or more of the plurality of private content items that are accessible to the particular user to provide accessible private content items;
modifying the search query to include one or more restrictions, the one or more restrictions specifying that only the accessible private content items of the plurality of private content items are accessible to the particular user;
identifying, based on a search of the content identifiers of the private content Index, one or more of the plurality of the accessible private content items i) based on the one or more restrictions and ii) that are responsive to the one or more search terms of the search query;
identifying, based on a search of public content, public content items that are responsive to the one or more search terms; and
sending, to the client device, search results including i) the identified accessible private content items and ii) the public content items.

16. (canceled)

17. (canceled)

18. The electronic system of claim 15, wherein the private content index is remote from the client device.

19. The electronic system of claim 15, wherein the accessible private content items are not accessible to one or more other users that differ from the first user.

20. The electronic system of claim 15, wherein the operations further comprise:
comparing the user information to information in the access control lists.

21. The method of claim 1, wherein the content identifier further includes reference information specifying a uniform resource location of the private content item.

22. The method of claim 1, further comprising:
for each private content item, formatting the private content item based on one or more parameters of the private content index to provide a formatted private content item,
wherein generating, for each private content item, the index item further comprises generating, for each formatted private content item, the index item.
